(19) United States
(12) Patent Application Publication
(10) Pub. No.: US 2008/0104601 A1
(43) Pub. Date: May 1, 2008

(54) Scheduler for multiple software tasks to share reconfigurable hardware

(75) Inventors: Naoto Kaneko, Tokyo (JP); Kiyotaka Takahashi, Saitama (JP)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/586,568

(22) Filed: Oct. 26, 2006

(51) Int. Cl. G06F 9/46

(52) U.S. Cl. 718/103

(57) ABSTRACT

Software tasks executing on a computer system, such as run-time applications in a real-time operating system (RTOS), are scheduled with respect to requested use of a reconfigurable hardware device on the system. Configuration data associated with the software tasks may be loaded or unloaded based on a priority level associated with the device request, the time of the request, and the current state of the configuration memory of the device. Additionally, statistics regarding device usage and application execution history are used to anticipate a device request from a software task, and to preemptively load configuration data for the software task into the configuration memory of the device.

### BACKGROUND

The performance of many modern computer systems is affected by the processing burden imposed on the system, which in many cases far exceeds the optimal processing load of the system as originally designed. A common example of this problem relates to real-time operating systems (RTOS's), or operating systems designed to support processor-intensive run-time applications. Specifically, an RTOS may provide support for changing the priority levels of the executing software applications at any time, and processing data fast enough to enable real-time communication between applications, such as embedded applications, running on the system.

To increase the overall processing power of the computer system, a reconfigurable hardware device may be integrated into the system. A reconfigurable hardware device is a programmable integrated-circuit device that allows for run-time reprogramming of its logic configuration. Known reconfigurable devices include the Dynamically Reconfigurable Hardware (DRHW) such as the DRP-1 device manufactured by the NEC Corporation, or a Field Programmable Gate Array (FPGA), such as the Virtex-II product line manufactured by the Xilinx Corporation. Reconfigurable devices may have an on-chip configuration data memory storing configuration data that defines the circuit configuration of the device. However, currently, configuration data loading happens only once during the system start-up. A configuration request is typically hard-coded inside the boot sequence through the operating-system's device driver interface.

Although run-time reconfiguration of such a device could potentially provide performance benefits, run-time reconfiguration is uncommon for several at least two major reasons. First, a software task attempting to invoke a run-time reconfiguration of a reconfigurable hardware device is often unable to control the schedule by which the request and processing will be handled by the device. For example, in many conventional systems, the reconfigurable device is accessed through a device driver interface that is based on a simple first-in first-out locking mechanism. Thus, the device will not become available to the software until every other previously submitted request has been completed. Such delays and uncertainties are often unacceptable to run-time applications.

Another difficulty with using reconfigurable devices in conventional systems is the large performance and power overhead associated with loading data from a software task into the configuration memory of the device. Configuration data sent from the software task is often a large amount of data, requiring many cycles for loading. Thus, the potential performance gains from parallel processing with the reconfigurable device may be offset by the pre-processing loading time. Such delays are accentuated in real-time systems when many different software tasks may be requesting use of the device, resulting in higher rates of loading and unloading.

In view of these difficulties, run-time reconfiguration of reconfigurable devices is not commonly used in many computer systems. Accordingly, there remains a need for systems and methods for scheduling usage of reconfigurable devices among multiple software tasks.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a scheduler is implemented to receive requests from software tasks (e.g., run-time applications) attempting to make use of the reconfigurable hardware device. The scheduler may store the requests from the different software tasks in queues based on request priority, the time of the request, the configuration memory of the device, and other factors. For example, the scheduler might grant immediate access to a software task whose configuration data is already loaded into the device, thereby preventing unnecessary loading and unloading. After determining which of the software tasks will be granted access to the device, the scheduler may initiate the configuration data loading for the task, and notify the task that it may proceed to use the device.

According to another aspect of the present disclosure, a speculator is implemented to preemptively load configuration data into the configuration memory of the device even before the associated software task has made a request for use of the device. The speculator may determine which of many different software tasks has a greater likelihood of requesting use of the device in the near future. Statistics are gathered relating to the execution of the software tasks, the past usage of the device and scheduler, among other factors, and are used to calculate a score for each of the different software tasks. For example, the software task with a high score may be deemed more likely, based on past and present information, to request the device in the near future. Thus, the speculator may initiate the loading of the configuration data for the selected software task in the configuration memory of the device. According to yet another aspect of the present invention, similar calculations may be made to determine that one or more sets of configuration data in the configuration memory are to be unloaded, based on a lesser likelihood that the software task corresponding to the configuration data will request the use of the reconfigurable device in the near future.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a computing device, in accordance with aspects of the present invention;

FIG. 2 is a component diagram illustrating a computing device configured as a task scheduler, in accordance with aspects of the present invention;

FIG. 3 is a flow diagram showing illustrative steps for receiving a request from a software task for access to a reconfigurable device, in accordance with aspects of the present invention;

FIG. 4 is a flow diagram showing illustrative steps for performing a software task using a reconfigurable device, in accordance with aspects of the present invention; and

FIG. 5 is a flow diagram showing illustrative steps for performing a speculative loading of a configuration memory of a device, in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

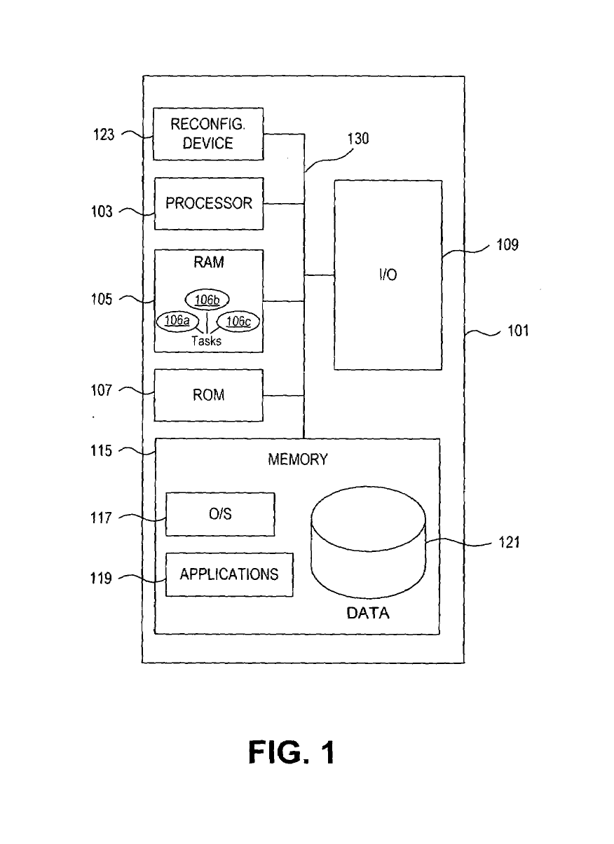

FIG. 1 illustrates a block diagram of a generic computing device 101 that may be used according to an illustrative embodiment of the invention. Device 101 may have a processor 103 for controlling overall operation of the computing device and its associated components, including RAM 105, ROM 107, input/output module 109, and memory 115. Also shown inside the RAM 105 are applications 106a-106c, representing the application data stored in RAM memory 105 while the computer is on and corresponding software applications (e.g., software tasks), are running on the computer 101.

I/O 109 may include a microphone, keypad, touch screen, and/or stylus through which a user of device 101 may provide input, and may also include one or more of a speaker for providing audio output and a video display device for providing textual, audiovisual and/or graphical output.

Memory 115 may store software used by device 101, such as an operating system 117, application programs 119, and associated data 121. In certain implementations, the operating system 117 may be a real-time operating system (RTOS). An RTOS 117 is an operating system designed to support run-time applications, often embedded applications. More specifically, the RTOS 117 may be developed and configured to allow the priority levels of software tasks to be changed quickly at any time, and to rapidly process results from one software task for simultaneous input for the results into another task.

Additionally, an application program 119 used by device 101 according to an illustrative embodiment of the invention may include computer executable instructions for invoking user functionality related to communication, such as email, short message service (SMS), and voice input and speech recognition applications.

Device 101 may also be part of a mobile communication system. Such systems are well-known in the art to include one or more base stations communicating with one or more mobile terminals via radio communication. The device 101 may be a base station in such a system, configured to perform baseband and radio frequency processing. The device 101 may also be a mobile terminal including various other components, such as a battery, speaker, and antennas (not shown). I/O 109 may include a user interface including such physical components as a voice interface, one or more arrow keys, joy-stick, data glove, mouse, roller ball, touch screen, or the like. Additionally, the memory 115 of computer 101 may be implemented with any combination of read only memory modules or random access memory modules, optionally including both volatile and nonvolatile memory and optionally being detachable. Software may be stored within memory 115 and/or storage to provide instructions to processor 103 for enabling computer 101 to perform various functions. Alternatively, some or all of computer 101 computer executable instructions may be embodied in hardware or firmware (not shown). Additionally, device 101 may be a mobile terminal configured to send and receive transmissions through various device components, such as an FM/AM radio receiver, wireless local area network (WLAN) transceiver, and telecommunications transceiver (not shown). In one aspect of the invention, mobile terminal 101 may receive radio data stream (RDS) messages. Mobile terminal 101 may be equipped with other receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal 101 may share parts or subassemblies with one or more other receivers in the mobile terminal device, or each receiver may be an independent subassembly.

One or more reconfigurable hardware device 123 may also be integrated into the computer 101 and connected to the other components using a bus 130. As mentioned above, a reconfigurable hardware device 123 is a class of programmable integrated-circuit devices that allow for the run-time reprogramming of its logic configuration. For example, the reconfigurable device 123 may be a Dynamically Reconfigurable Hardware (DRHW) or a Field Programmable Gate Array. A reconfigurable device 123 may have a configuration plane 124 and an on-chip configuration data memory 125 (not shown in FIG. 1) storing configuration data that defines the circuit configuration of the device. Thus, by loading a block of configuration data onto the configuration data memory, the reconfigurable hardware is programmed to embody the defined logical function on the configuration data block. As the name implies the device 123 is reconfigurable, allowing many instances of programming and re-programming of the reconfigurable device 123, for example, while the RTOS 117 is processing multiple software tasks 106a-106c in the real-time system. In other words, run-time reconfigurability of the device 123 may allow the device 123 to act as the shared accelerator engine for the software tasks running on the computer 101.

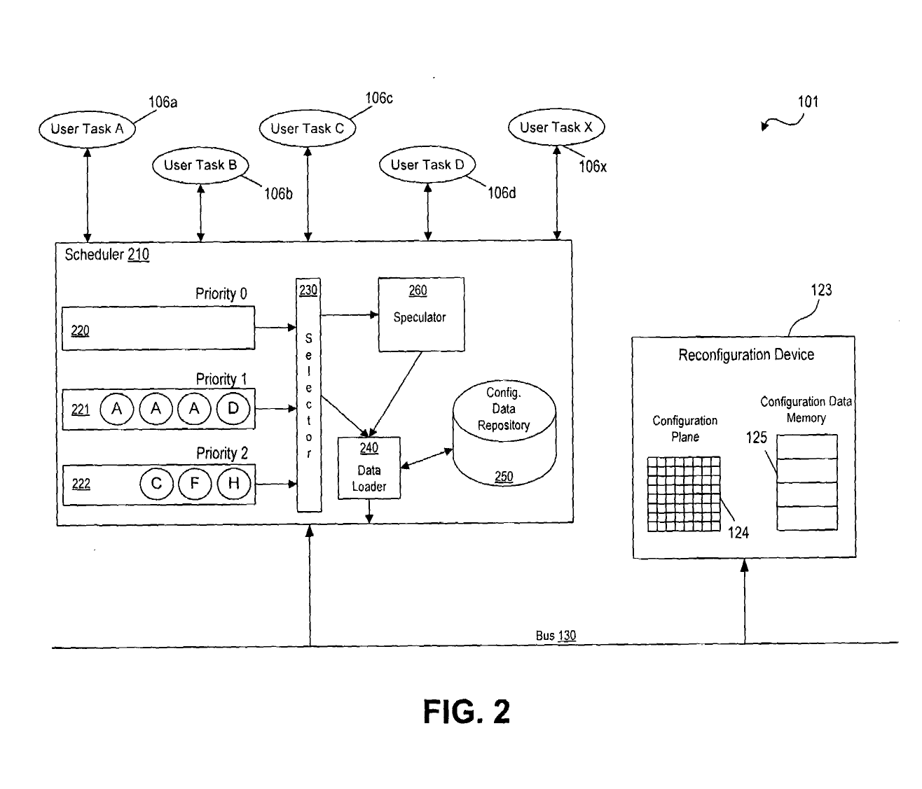

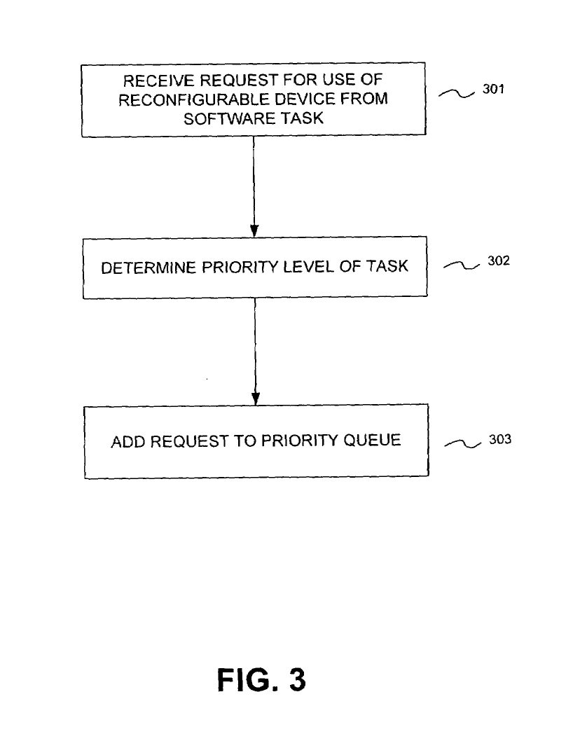

Referring to FIG. 2, a block diagram is shown illustrating the logical components of a computing device 101 configured to perform task scheduling and speculative loading in accordance with aspects of the present invention. Clearly, the logical components of the device 101 need not correspond to separate physical components within the device, but may likely be implemented as software components executing within the hardware infrastructure described in FIG. 1 above. Additionally, one or more of the logical components of the scheduler 210 may be combined into a single software component. For example, the data loader 240 may be implemented as autonomous software component, such as a loader library function in a software library installed on the computer 101. Alternatively, the data loader 240 may be implemented as certain segments of software executing in a combined scheduler function that contains the selector 230, the priority queues 220-222, and other logical components in the scheduler 210. As discussed in greater detail below, the scheduler 210 may be implemented on the computer 101 in several different ways. Nevertheless, the logical component diagram shown in FIG. 2 allows several different functions of the scheduler 210 to be discussed individually. Each logical component will be briefly introduced below, before being discussed in detail in reference to FIGS. 3-5.

Priority Queues—The priority queues 220-222 may be implemented as conventional first-in-first-out (FIFO) data queues storing requests from the software tasks executing on the computer 101 for use of a reconfigurable hardware device.

Selector—The selector 230 may contain the logical functionality to detect requests in the priority queues 220-222, and to remove and read and selected request from a queue.

Data Loader—The data loader 240 may receive the selected request from the selector 230, then retrieve the appropriate configuration data from the configuration data repository 250, to load the configuration data storage block in the configuration memory 125 of the device 123.

Configuration Data Repository—The configuration data repository 250 may contain copies of the configuration data storage blocks for each software task currently executing on the computer 101.

Speculator—The speculator 260 may be invoked to determine which configuration data storage block to load into the configuration memory 125, when the device 123 becomes available and when there are no pending requests in the priority queues.

Referring to FIG. 3, a flow diagram is shown illustrating a scheduler 210 receiving a request from a software task 106x for access to a reconfigurable device 123, in accordance with aspects of the present invention. In step 301, when a software task 106x executing on the computer 101 attempts to use the reconfigurable device 123, it sends a task request to the scheduler 210. The scheduler 210 receives the request, which may include information identifying the configuration data associated with the request, and a priority level of the request. The information identifying the configuration data may be a name (or other identifier) corresponding to a configuration storage block stored in the configuration data repository 250. In certain implementations, each software task may be restricted to using the reconfigurable device 123 with a single configuration data block. In such an example, the correct configuration data may be identified simply by an identifier of the task itself, for example, with an operating system unique process ID. However, in configurations that permit a single software task 106x to use the reconfigurable device 123 with multiple configuration data blocks, a software task ID (e.g., operating system process ID) might not uniquely identify the correct configuration data in the data repository 250. Thus, the correct configuration data might include both a task identifier and a configuration data identifier, or just a unique configuration data name. Through the use of configuration data names, it may also be possible for multiple software tasks 106x on the computer 101 to share the same set of configuration data.

In step 302, the scheduler 210 determines the priority level of the new request. The priority level of the request may be expressly passed in by the software task 106x, or may be determined by the scheduler 210, for example, based on the operating system priority of the software task 106x. Thus, the software task itself may be permitted to assign its own requests to the appropriate priority level, so that time-sensitive requests may be granted before other less urgent requests.

In step 303, after the scheduler 210 has determined the priority level of the request, the request is stored the corresponding priority queue 220-222. While only three priority queues are shown in FIG. 2, queue 220 corresponding to the highest priority requests, queue 221 corresponding to the next highest priority requests, and queue 220 corresponding to the lowest priority requests, additional queues may be included as needed. The number of priority queues 220-222 may depend on the number of software task priority levels defined by the operating system 117, or may be determined at the discretion of the scheduler 210 (e.g., for optimal scheduler 210 performance based on the expected request throughput at the queues 220-222).

The execution of the steps of FIG. 3 in a repeating loop will continuously fill the queues 220-222 and maintain an order of the pending requests submitted to the scheduler 210 according to both priority and arrival time of the request. In order to avoid missing requests from the software tasks 106x, the scheduler 210 may execute these steps in a service, or persisting operating system process, or in another function running continuously on the computer 101.

As mentioned above, there are many different potential implementations of the scheduler 210, along with the related components such as the speculator 260 and the configuration data loader 240. In one possible implementation, the scheduler 210 and related components are implemented as a set of functions in a software library that are invoked directly by each software task 106x. The queues 220-222 and other configuration data repository 250 may be implemented using shared storage resource (e.g. shared memory and/or file system storage) in combination with a locking mechanism (e.g. semaphores and/or messaging). In this example, the request is made with a regular function call to the library, and the actual loading is executed by the data loader 240 through the regular device driver interface for the reconfigurable device 123.

In another potential implementation, the scheduler 210 may be a system service or server process, for example, a daemon in a UNIX-based operating system. The scheduler server process is a software task 210 that runs continuously to accept requests from the other software tasks 106x. In this example, the request is made through inter-process communication, and the data loading is once again executed by the data loader 240 via the regular device driver interface for the reconfigurable device 123.

In yet another implementation, the scheduler 210 is implemented as an operating system kernel function. There are several techniques available for implementing the proposed functionality in the kernel space. One technique is to build the scheduler 210 inside the device deriver for the reconfigurable device 123. In this example, the software tasks 106x make requests through the regular device driver interface, and the requests are received by the scheduler 210 inside the device driver.

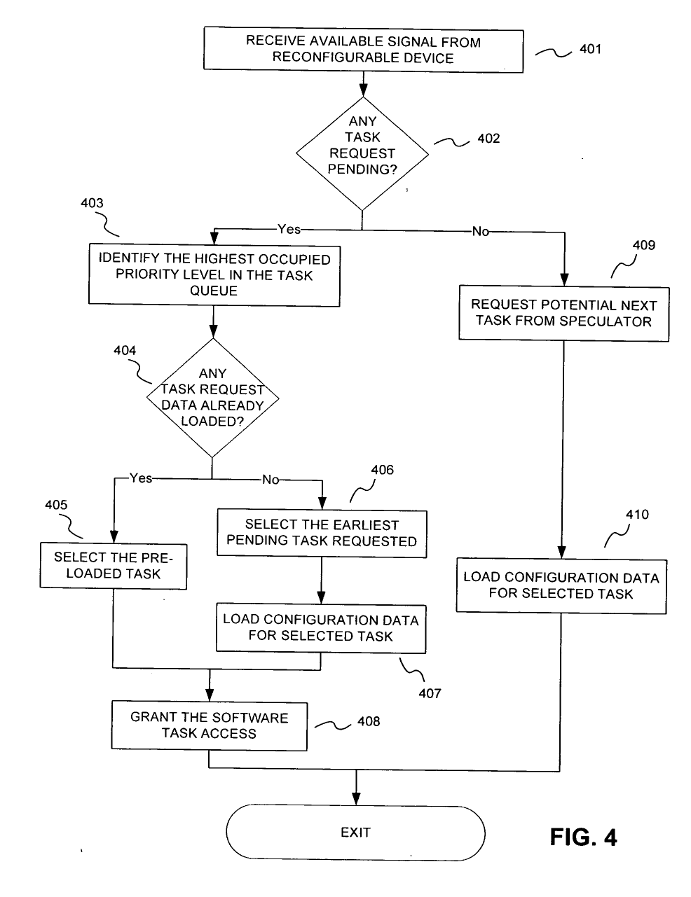

Referring to FIG. 4, a flow diagram is shown illustrating the scheduling and executing a task request in accordance with aspects of the present invention. In step 401, the scheduler 210 receives a signal from the reconfigurable hardware device 123 indicating that the device 123 is available for use by one of the software tasks 106x. As mentioned above, software tasks 106x may accelerate the processing rate of certain tasks and thus increase the overall performance of the task by employing the reconfigurable hardware device 123 to handle a portion of the task's processing duties. Thus, in step 402, after receiving the available signal from the reconfigurable device 123, the scheduler first determines if there are any pending task requests by examining the queues 220-222. If there is at least one pending task request (402:Yes), then the scheduler 210 will select which of the pending tasks will be performed next by the reconfigurable device 123 in steps 403-406.

In step 403, the scheduler 210 identifies the highest priority queue 220-222 with a pending task request. In FIG. 2, for example, the queue highest priority queue 220 does not contain any pending task requests. Thus, the next highest priority queue 221 is selected in step 403, so that the scheduler 210 may ensure that one of the tasks from queue 221 is selected next for execution. Thus, in this example, a lower priority task request will never be executed before a higher priority task request. However, in other possible implementations, the priority level of the request may be just one of several factors equally considered in the ultimate determination, and therefore might not be determinative.

In step 404, each request in the selected queue 221 is examined to determine whether the associated configuration data for the request is already loaded into the configuration memory 125 of the reconfigurable device 123. If one or more pending request is already loaded in the memory 125 (404:Yes), then the one of these pre-loaded requests closest to the front of the priority queue is selected in step 405. Since the configuration data for this request is already loaded, control proceeds to step 408, where the software task that initiated the request is notified that the reconfigurable device 123 is available for processing and the correct configuration data is loaded into the configuration memory 125. Thus, in this example, time-consuming loading and unloading of data into the configuration device memory 125 may be avoided by recognizing and taking advantage of the configuration data already loaded in memory 125.

If none of the pending requests at the highest priority level are loaded in the memory 125 (404:No), then the scheduler 210 may use one or more additional criteria for determining which request to select. Thus, in step 406, the determination is made based on the time the request was added to the priority queue (i.e., the request at the front of the queue). In other configurations, the size of the configuration data, the amount of available device memory 125, the anticipated execution time, and other factors discussed below in relation to the speculator 260, may be considered instead of or in addition relying on the time that the request was added to the queue.

In step 407, if the configuration data for the selected request is not pre-loaded into the device memory 125, then the data loader 240 is used to retrieve the corresponding configuration data from the repository 250 and transmit that data over the bus 130 to the configuration memory 125 on the reconfigurable device 123. Then, in step 408, since the appropriate configuration data is loaded into the memory 125 of the configuration device 123, regardless of whether the request was selected in step 405 or step 406), the scheduler may now notify the corresponding software task 106x that it is free to use the reconfigurable device 123 for processing.

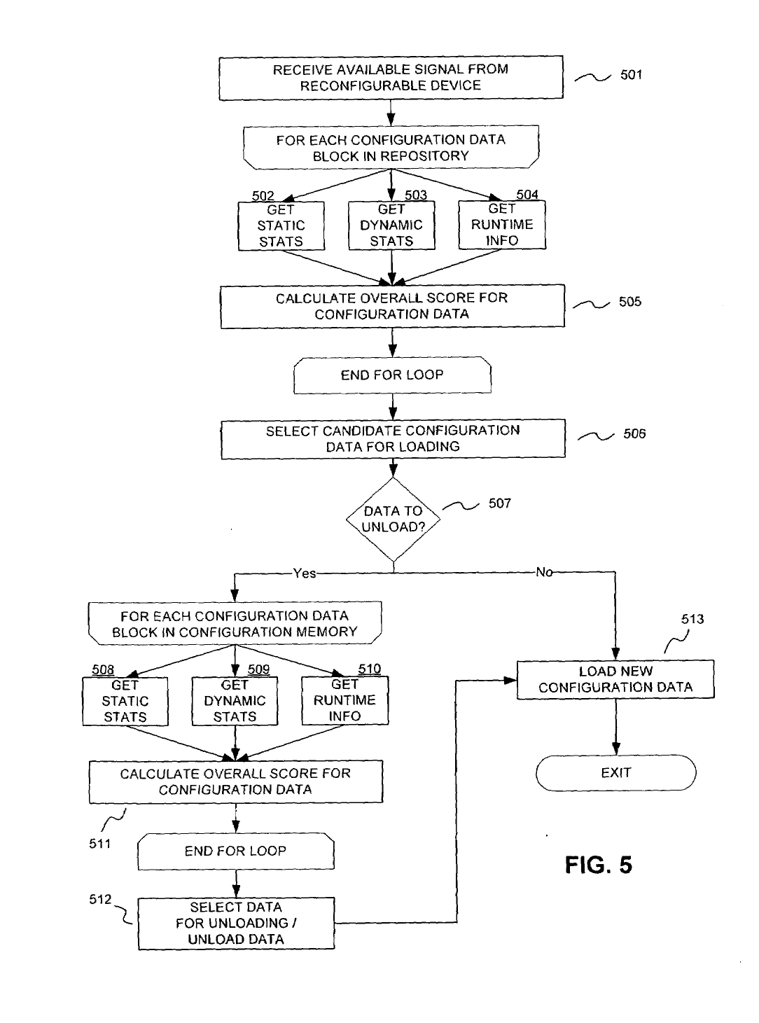

Returning to step 402, if there are no pending requests (402:No), then in step 409 the speculator 260 is used to determine which configuration data from the configuration data repository 250 should be loaded into the configuration memory 125. The techniques used by the speculator 260 to make this determination are described in detail below in reference to FIG. 5. Once this determination is made, the data loader 240 is invoked to retrieve the configuration data from the repository 250 and load the data into the configuration memory 125. Of course, if the speculator 260 is used to determine which configuration data to load, then the corresponding software task 106x need not be notified, since that task has not yet made a request for the device 123. However, as soon as the software task makes a request for the reconfigurable device 123, the scheduler 210 may at once determine that the configuration data has been pre-loaded, and may immediately notify the task that the request is granted.

Referring now to FIG. 5, a flow diagram is shown illustrating the operation of the speculator 260 for selecting configuration data for loading into the configuration memory 125. As mentioned above, the functional steps 501-512 performed by the speculator 260 may be sub-steps of the step 409 in the process shown in FIG. 4. In this example, the speculator 260 is first invoked by the selector 203 in step 501. The signal received by the speculator 260 indicates both that the reconfigurable device 123 is available for use, and that there are no pending requests in the priority queues 220-222. Thus, the speculator 260 may determine that a configuration data block from the repository 250 should be loaded into the configuration memory 125 (in steps 502-505). The speculator 260 may also determine one or more configuration data blocks that should be unloaded from the configuration memory 125 (in steps 509-513) to make room for the new configuration data. As the name implies, the speculator 260 performs these determinations based on information available to the scheduler 210 that might indicate a higher probability that the software task associated with the selected configuration data will request use of the reconfigurable device 123 in the near future, and similarly a lower probability that the configuration data to be unloaded will be needed by the device 123 in the near future. In certain implementations, the functional steps of the speculator 260, including the loading of additional configuration data, may occur even while the reconfigurable device is executing a task.

As mentioned above, in steps 502-506, the set of potential loading candidates are evaluated to determine which one or more of the candidates should be loaded into the configuration memory 125. The set of possible candidate may consist of the configuration data blocks in the repository 250 (which may also correspond to the software tasks currently running on the computer 101), excluding the configuration data that is already in the configuration memory 125 (i.e., the configuration data that is currently in use by a software task 106x, but not currently loaded by the reconfigurable device 123). Thus, a similar set of calculations may be performed for each configuration data candidate. Of course, the evaluation of potential loading candidates in steps 502-506 may also include evaluations of currently loaded configuration data. If the configuration data nominated by the speculator 260 is already in the configuration memory 125, then the scheduler 210 may determine that no speculative data loading needs to occur at that time.

In step 502, the “static” statistics are gathered for the configuration data candidates. The static statistics may include, for example, the size of the configuration data. As another example, the static statistics may relate to user pre-defined information based on the designer's knowledge of the process structure in the system. For instance, in a scheduler 210 executing in a baseband processor 103, a designer may know that a first task (e.g., Turbo decoding) typically executes shortly after a second task (e.g., constellation mapping). Thus, the designer may pre-define “static” statistics used by the speculator 260, making it more likely that the configuration data for the first task will be nominated when the current configuration includes the configuration data for the second task.

In step 503, the “dynamic” statistics are gathered for the configuration data candidates. The dynamic statistics may include, for example, the amount of time required to load the configuration data into the configuration memory (e.g., as recorded during previous loading operations, or estimated based on the size of the configuration data), the frequency at which the configuration data has been loaded into the configuration memory 125 over a recent period of time, the frequency at which the loaded configuration data has been used by the device 123 over a recent period of time, the executing history of the associated software task 106x, the idle time of the reconfigurable device 123, and the amount of configuration memory 125 currently available. In step 504, relevant operation system run time information is gathered, for example, the execution states of each of the software tasks on the computer 101, the priorities of the software tasks, the order of the tasks in the software task queues, and the availability of the communication bus 130 to the configuration memory 125.

In step 505, the speculator 260 performs a calculation for each configuration data candidate, based on the static and dynamic statistic data and the system run time information described above. In certain implementations, not every statistic listed above need be input as a variable into the final calculation for each configuration data candidate, but rather a subset of the variables may be used in the calculation. The calculations in step 505 may produce a single number, effectively a score for the candidate, which may be compared to the other candidate scores in step 506. The candidate with the highest score is selected by the scheduler 210 to have its configuration data loaded into the configuration memory 125 of the device 123. Accordingly, in step 513, the speculator 260 may provide a configuration data identifier or the configuration data name to the data loader 240, which retrieves the selected configuration data and transmits the data across the bus 130 to the configuration memory 125. In one example, run-time statistics may be used to build a Markov model describing which configuration data blocks are more likely to be loaded after which other configuration data blocks. Then, in step 506, the speculator 260 uses the Markov model and the currently loaded configuration(s) to determine the most probable next configuration data block.

Another aspect of the speculator 260 relates to the unloading of data currently residing in the configuration memory 125. In step 507, it may be determined that there is insufficient memory available in the configuration memory 125 for storing the to-be-loaded configuration data selected in step 506. Thus, in steps 508-512, a similar process may be performed by the speculator 260 to determine which of the existing configuration data blocks should be unloaded. In a simple embodiment, only one configuration data block may be stored in the configuration memory 125 at a time, so that every new loading operation requires a prior unloading. In such an embodiment, the statistics retrieved and the calculations performed in steps 508-511 would not be necessary. However, in other common implementations, multiple configuration data blocks (e.g., for multiple software tasks 106x) may be stored simultaneously, and the decision to remove a configuration data block is determined by the measurements and calculations of steps 508-511, which ultimately determine which configuration data is least likely to be used again by the device 123 in the near future. In fact, the calculations in step 511 may be exactly same as the calculations in step 505, the only difference being that the configuration data with the lowest score may be selected for unloading, rather than the highest score being selected for loading. In step 512, the configuration data selected in step 511 is unloaded from the configuration memory 125, allowing the configuration data selected in step 506 to be loaded.

Of course, the process shown in FIG. 5 for using the speculator 260 to preemptively load and unload data from the configuration memory 125 need not only be performed a single time, and need not be limited to executing only immediately following the receipt of the available signal in step 501. For example, configuration data block may be loaded or unloaded even while the device 123 is processing using different configuration data loaded for a different software task 106x. Additionally, multiple iterations of the loading/unloading process may determine that an efficiency gain can be expected by unloading and replacing more than one set of configuration data. It is even possible that every currently loaded configuration data block may be preemptively removed from the configuration storage 125 by the speculator 260, if the speculator 260 determines that several unloaded configuration data blocks associated with software tasks 106x are more likely to use the reconfigurable device 123 than any of the currently loaded configuration data. Furthermore, because configuration data blocks may vary in size, it may be necessary to unload more than one block before loading the single configuration data block selected in step 506, or vice versa.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. An electronic device, comprising:
a processor controlling at least some operations of the electronic device;
a memory storing computer executable instructions that, when executed by the processor, cause the electronic device to perform a method for scheduling software tasks, the method comprising:
receiving from a first software task a first request for use of a reconfigurable hardware device;
determining a first priority level associated with the first request;
storing configuration data associated with the first request;
determining that the first request is to be granted, based at least in part on the first priority level; and
providing the first software task with access to the reconfigurable hardware device.

2. The electronic device of claim 1, wherein the method further comprises:
determining that the configuration data associated with said first request is not currently loaded into a configuration memory of the reconfigurable hardware device; and
based on said determination, loading said configuration data into the configuration memory before providing the first software task with access to the reconfigurable hardware device.

3. The electronic device of claim 2, wherein the method further comprises:
before loading said configuration data, determining a first load time corresponding to an amount of time required to load said configuration data into the configuration memory, wherein providing the first software task with access to the reconfigurable hardware device comprises transmitting at least one of the first load time and a time value corresponding to the commencement of the loading.

4. The electronic device of claim 2, wherein the method further comprises:
before loading said configuration data into the configuration memory, removing different configuration data associated with a second software task.

5. The electronic device of claim 4, wherein removing the different configuration data comprises determining a reduced likelihood that the second software task will subsequently request the reconfigurable hardware device.

6. The electronic device of claim 1, wherein the determining comprises:
determining not to grant a second request with an earlier arrival time than the first request based on a second priority level associated with the second request.

7. The electronic device of claim 1, wherein the determining is based in part on a determination that the configuration data associated with said first request is currently loaded into the configuration memory of the reconfigurable hardware device.

8. The electronic device of claim 5, wherein the method is performed within a real-time operating system (RTOS) running on the electronic device.

9. The electronic device of claim 8, wherein the method is performed by an operating system kernel function.

10. The electronic device of claim 8, wherein the method is performed by one or more library functions outside of the operating system.

11. A method, comprising:
receiving from a first software task a first request for use of a reconfigurable hardware device;
determining a first priority level associated with the first request;
storing configuration data associated with the first request;
determining that the first request is to be granted based at least in part on the first priority level; and
providing the first software task with access to the reconfigurable hardware device.

12. The method of claim 11, further comprising:
determining that the configuration data associated with said first request is not currently loaded into a configuration memory of the reconfigurable hardware device; and
based on said determination, loading said configuration data into the configuration memory before providing the first software task with access to the reconfigurable hardware device.

13. The method of claim 12, further comprising:
before loading said configuration data, determining a first load time corresponding to an amount of time required to load said configuration data into the configuration memory, wherein providing the first software task with access to the reconfigurable hardware device comprises transmitting at least one of the first load time and a time value corresponding to the commencement of the loading.

14. The method of claim 12, further comprising:
before loading said configuration data into the configuration memory, removing different configuration data associated with a second software task.

15. The method of claim 14, wherein removing the different configuration data comprises determining a reduced likelihood that the second software task will subsequently request the reconfigurable hardware device.

16. The method of claim 15, wherein the determining comprises:
determining not to grant a second request with an earlier arrival time than the first request based on a second priority level associated with the second request.

17. The method of claim 15, wherein the determining is based in part on a determination that the configuration data associated with said first request is currently loaded into the configuration memory of the reconfigurable hardware device.

18. The method of claim 15, wherein the method is performed by a computer terminal running a real-time operating system (RTOS).

19. The method of claim 18, wherein the method is performed by an operating system kernel function.

20. The method of claim 18, wherein the method is performed by one or more library functions outside of the operating system.

21. A computing device, comprising:
a processor controlling at least some operations of the computing device;
a memory storing computer executable instructions that, when executed by the processor, cause the computing device to perform a method for loading configuration data onto a reconfigurable hardware device, the method comprising:
identifying a plurality of software tasks executing on the computing device;
determining that none of the plurality of software tasks has a request pending for use of a reconfigurable hardware device connected to the computing device;
for each of the plurality of software tasks, determining a likelihood that the software task will subsequently request use of the reconfigurable hardware device;
selecting a first software task based on the likelihood that the first software task will subsequently request use of the reconfigurable hardware device; and
loading configuration data associated with the first software task into a configuration memory of the reconfigurable hardware device.

22. The computing device of claim 21, wherein the method further comprises:
for each of the plurality of software tasks, determining the size of the configuration data associated with the software task,
wherein selecting the first software task is further based on the configuration data sizes associated with the software tasks and the amount of configuration memory available.

23. The computing device of claim 21, wherein the method further comprises:
for each of the plurality of software tasks, determining a priority level of the software task,
wherein selecting the first software task is further based on the priority levels of the software tasks.

24. The computing device of claim 21, wherein each determination of the likelihood that a software task will subsequently request use of the reconfigurable hardware device comprises:
determining the number of times that the software task has used the reconfigurable hardware device over a predetermined period of time; and
determining the number of times that the configuration data associated with the first software task has been loaded into the configuration memory over a predetermined period of time.

25. The computing device of claim 21, wherein the method further comprises:
identifying a plurality of configuration data storage blocks stored in the configuration memory, each configuration data storage block associated with one of the plurality of software tasks;
for each configuration data storage block, determining a likelihood that the associated software task will subsequently request use of the reconfigurable hardware device;
selecting a first configuration data storage block based on the reduced likelihood that the associated software task will subsequently request use of the reconfigurable hardware device; and
unloading the first configuration data storage block from the configuration memory.

26. The computing device of claim 25, wherein determining the reduced likelihood that the software task associated with each configuration data storage block will subsequently request use of the reconfigurable hardware device comprises determining an execution state of each of the associated software tasks.

27. The computing device of claim 25, wherein selecting the first configuration data storage block is further based on the size of the first configuration data storage block.

28. A method, comprising:
identifying a plurality of software tasks executing on a computer system;
determining that none of the plurality of software tasks has a request pending for use of a reconfigurable hardware device on the computer system;
for each of the plurality of software tasks, determining a likelihood that the software task will subsequently request use of the reconfigurable hardware device;
selecting a first software task based on the likelihood that the first software task will subsequently request use of the reconfigurable hardware device; and
loading configuration data associated with the first software task into a configuration memory of the reconfigurable hardware device.

29. The method of claim 28, further comprising:
for each of the plurality of software tasks, determining the size of the configuration data associated with the software task,
wherein selecting the first software task is further based on the configuration data sizes associated with the software tasks and the amount of configuration memory available.

30. The method of claim 28, further comprising:
for each of the plurality of software tasks, determining a priority level of the software task,
wherein selecting the first software task is further based on the priority levels of the software tasks.

31. The method of claim 28, wherein each determination of the likelihood that a software task will subsequently request use of the reconfigurable hardware device comprises:
determining the number of times that the software task has used the reconfigurable hardware device over a predetermined period of time; and
determining the number of times that the configuration data associated with the first software task has been loaded into the configuration memory over a predetermined period of time.

32. The method of claim 28, further comprising:
identifying a plurality of configuration data storage blocks stored in the configuration memory, each configuration data storage block associated with one of the plurality of software tasks;
for each configuration data storage block, determining a likelihood that the associated software task will subsequently request use of the reconfigurable hardware device;
selecting a first configuration data storage block based on the reduced likelihood that the associated software task will subsequently request use of the reconfigurable hardware device; and
unloading the first configuration data storage block from the configuration memory.

33. The method of claim 32, wherein determining the reduced likelihood that the software task associated with each configuration data storage block will subsequently request use of the reconfigurable hardware device comprises determining an execution state of each of the associated software tasks.

34. The method of claim 32, wherein selecting the first configuration data storage block is further based on the size of the first configuration data storage block.
